(19) United States
(12) Patent Application Publication
(10) Pub. No.: US 2014/0007363 A1
(43) Pub. Date: Jan. 9, 2014

(54) APPARATUS FOR CLEANING PAINT MINI ROLLER COVERS

(71) Applicants: Mario KOVARIK, North Delta (CA); Erkin AYCAN, Abbotsford (CA)

(72) Inventors: Mario KOVARIK, North Delta (CA); Erkin AYCAN, Abbotsford (CA)

(21) Appl. No.: 13/936,045

(22) Filed: Jul. 5, 2013

Related U.S. Application Data
(60) Provisional application No. 61/668,290, filed on Jul. 5, 2012.

(51) Int. Cl. B44D 3/00

(52) U.S. Cl. CPC B44D 3/006
USPC 15/94

(57) ABSTRACT

A paint spinner adapter for mini roller covers is provided. The adapter includes: a first rod comprising a first end and a second end, the first rod configured to be friction fittable within a first bore of a mini roller cover; a second rod comprising a first end a second end, the second rod configured to be friction fittable within a second bore of a different mini roller cover; wherein the second end of the first rod is connected to the second end of the second rod; wherein the second rod has a larger cross-sectional profile than the first rod; and wherein the second rod comprises opposing indentations configured for locking engagement with opposing ends of outer arms of a paint spinner.

### TECHNICAL FIELD

The invention relates to apparatus for cleaning paint mini rollers.

### BACKGROUND

Paint can be applied to a flat surface with a paint roller. A paint roller has a roller cover and a frame. The roller cover may be constructed of natural and/or synthetic fibers for absorbing and holding paint. The roller cover has a bore through its long axis. The frame includes a cylinder rotatably attached to a handle. The cylinder inserts into the bore of the roller cover so that the roller cover rotates about its long axis as a user gripping the handle moves the paint roller along a surface to be painted.

Paint rollers are available in a variety of sizes, including a standard size, which is typically about 9 to 12 inches in width, and a smaller size generally known as a mini roller, which is typically about 3 to 4 inches in width. Mini rollers are sometimes referred to as wizzy rollers, weenie rollers, or hotdog rollers. Mini rollers are useful for painting small areas, narrow areas, and areas that are otherwise difficult for standard-sized paint rollers to reach.

After or between uses, it is desirable to remove paint from a paint roller cover before the paint dries on the paint roller. Scraping or washing paint off of mini roller covers by hand is tedious and messy. Throwing away used mini roller covers is environmentally unsound and is costly for professional painters who may use dozens of mini rollers in a day.

For standard-sized roller covers, paint may be removed using a conventional paint spinner. A conventional paint spinner has opposed, inwardly-biased outer arms, and inner arms or mouth. When holding a paint brush, the opposing ends of the outer arms clamp around a mid portion of the brush handle, and the inner arms or mouth receive the end of the brush handle. When holding a standard-sized roller cover, the outer arms are friction fitted into the bore of the roller cover. A conventional paint spinner spins the paint brush or roller cover, inside a large pail, at a speed at which the adhesive force holding the paint to the roller cover doesn't provide enough centripetal force to overcome the inertia of the paint. At such a speed the retained paint is expelled from the brush or roller cover into the pail.

The bores of typical mini roller covers are too small to be fitted and retained on the arms of a conventional paint spinner. Adapters that allow mini roller covers to be cleaned with conventional paint spinners have been previously proposed. Known adapters have disadvantages including unwieldy design, poor fit, and incompatibility with mini roller covers of different bore sizes. An improved adapter for mini roller covers that addresses one or more of these disadvantages is desirable.

### SUMMARY

According to one aspect of the invention a paint spinner adapter for mini roller covers is provided. The adapter includes: a first rod comprising a first end and a second end, the first rod configured to be friction fittable within a first bore of a mini roller cover; a second rod comprising a first end a second end, the second rod configured to be friction fittable within a second bore of a different mini roller cover; wherein the second end of the first rod is connected to the second end of the second rod; wherein the second rod has a larger cross-sectional profile than the first rod; and wherein the second rod comprises opposing indentations configured for locking engagement with opposing ends of outer arms of a paint spinner.

The second rod may have a truncated circular cross-section. The first rod may have a substantially circular cross-section. At least a portion of the first rod may taper from a smaller cross-sectional profile to a larger cross-sectional profile from the first end to the second end. The first end of the second rod may have a tapered section. The second end of the second rod may have a tapered section. The second rod may include a flexibly deformable portion which projects away from the second rod, whereby when the second rod is inserted into the second bore, the flexibly deformable portion deforms and thereby generates a force against the interior surface of the bore. The first rod may have a diameter of approximately 0.235 inches. The second rod may have a width of approximately 0.740 inches. The indentations may be located at approximately the middle of the length of the adapter.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a side view of an adapter according to an example embodiment.

FIG. 2 is a top view of the adapter of FIG. 1.

FIG. 3 is a front view of the adapter of FIG. 1 on its bottom edge

FIG. 4 is a front view of the adapter of FIG. 1 on its side.

FIG. 5 is a top view of an adapter according to another example embodiment.

FIG. 6 is an isometric view of an adapter according to another example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Embodiments of the invention relate to adapters which can adapt a spinning mechanism for cleaning mini roller covers. The spinning mechanism may be a hand powered spinning mechanism, a conventional electric drill, or a spinning mechanism specifically designed for spinning paint rollers or paint brushes such as a conventional paint spinner. Some embodiments relate to adapters that can be used with mini roller covers with bores of at least two different sizes.

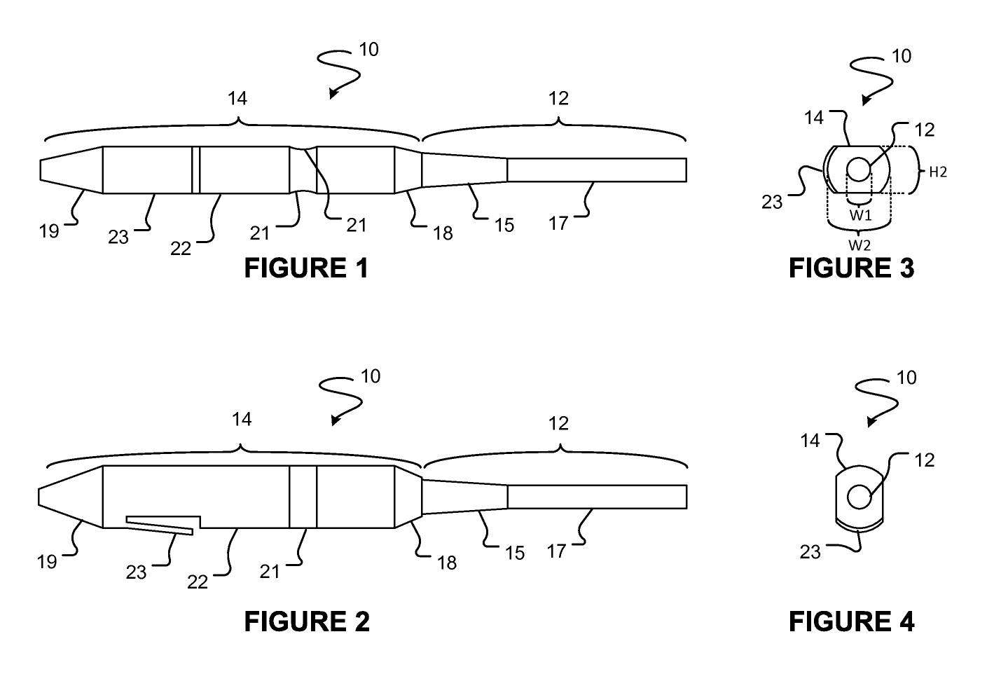

FIG. 1 is a side view of an adapter 10 according to an embodiment of the invention. Adapter 10 comprises a first rod 12 and a second rod 14. First rod 12 and second rod 14 are rigidly connected. The long central axes of first rod 12 and second rod 14 are substantially collinear. In some embodiments, first rod 12 and second rod 14 may be integrally formed as a single unit. In some embodiments, first rod 12 and second rod 14 may be detachably coupled to each other, for example by threaded male and female coupling members. Adapter 10 may be made of metal, wood, plastic, composite material, and/or any other suitable rigid material.

First rod 12 comprises a tapered portion 15 and a cylindrical portion 17. First rod 12 is dimensioned so that it can be at least partially inserted into a mini roller cover bore of a first size. Tapered portion 15 is dimensioned so that it can form a friction fit with the bore of the first size. In some embodiments, first rod 12 may comprise a rounded tip for ease of insertion into the bore of the first size. In some embodiments, tapered portion 15 may comprise a gradual taper that extends along the entire length of first rod 12, such that cylindrical portion 17 is absent. In some embodiments, as illustrated in FIG. 1, the length of tapered portion 15 may be only a fraction of the length of first rod 12. In other embodiments, tapered portion 15 may be absent, with cylindrical portion 17 providing adequate friction fit in the bore of the first size. In an example embodiment, first rod 12 may be approximately 3.375 inches long.

As shown in FIG. 3, first rod 12 has a circular cross-section. In other embodiments, first rod 12 may have any other cross-sectional shape that permits suitable friction fit with the bore of the first size, for example a polygon, a cross, a star, and the like. The term “suitable friction fit” as used in this specification means a friction fit at least sufficient to prevent relative rotation between the mini roller cover and the adapter as they are being spun by the spinning mechanism to remove paint. In an example embodiment, width W1 of first rod 12 is approximately 0.235 inches. In some embodiments, width W1 may range from 0.10 inches to 0.40 inches, or from 0.20 inches to 0.30 inches.

Second rod 14 is dimensioned so that it can be at least partially inserted into a mini roller cover bore of a second size. The bore of the second size is larger than the bore of the first size, and thus the diameter of the elongated body 22 of second rod 14 is larger than the diameter of first rod 12. Second rod 14 comprises a tapered first end 19 for ease of insertion of second rod 14 into the bore of the second size. When second rod 14 is inserted into a paint spinner, the flattened tip of tapered first end 19 facilitates insertion of second rod 14 between the outer arms of the paint spinner. The tapered first end 19 is received by the inner arms or mouth of the paint spinner. When first rod 12 is inserted into a paint spinner, second rod 14 also partially inserts into the paint spinner; in this situation, tapered second end 18 of second rod 14 facilitates the entry of second rod 14 between the outer arms of the paint spinner. In some embodiments, tapered first end 19 and/or tapered second end 18 may be absent. In an example embodiment, second rod 12 may be approximately 4.885 inches long, including a tapered first end approximately 0.775 inches long and a tapered second end approximately 0.340 inches long.

As shown in FIG. 4, second rod 14 has a truncated circular cross-section. The surfaces defined by the arcs of the truncated circle engage and provide a friction fit with the bore of the second size. The truncations are provided to mimic the cross-sectional shape of a conventional paintbrush handle, which is typically rectangular in shape, and thereby facilitate ease of insertion of second rod 14 through the outer arms of the paint spinner. In other embodiments, second rod 12 may have any other cross-sectional shape that permits suitable friction fit with the bore of the second size, for example a rectangle, an oval, and the like. In an example embodiment, width W2 of second rod 14 is approximately 0.740 inches, and height H2 of second rod 14 is approximately 0.516 inches. In some embodiments, width W2 may range from 0.50 inches to 0.90 inches, or from 0.60 inches to 0.80 inches, and height HW may range from 0.30 inches to 0.70 inches, or from 0.40 inches to 0.60 inches.

In some embodiments, second rod 14 comprises a flexibly deformable portion 23. Flexibly deformable portion 23 projects away from the rest of second rod 14, as can be best seen in FIG. 2, providing additional friction fit when second rod 14 is inserted in the bore of the second size. In some embodiments, a plurality of flexibly deformable portions may be provided on second rod 14. In other embodiments, flexibly deformable portion 23 may be absent, with elongated body 22 of second rod 14 providing adequate friction fit in the bore of the second size.

Second rod 14 also includes opposing indentations 21. Opposing indentations 21 are dimensioned to engage opposing ends of the outer arms of the paint spinner to provide a secure fit with the paint spinner. Generally, opposing indentations 21 are dimensioned for locking engagement with a corresponding feature (e.g. a chuck or a clamp) of the spinning mechanism.

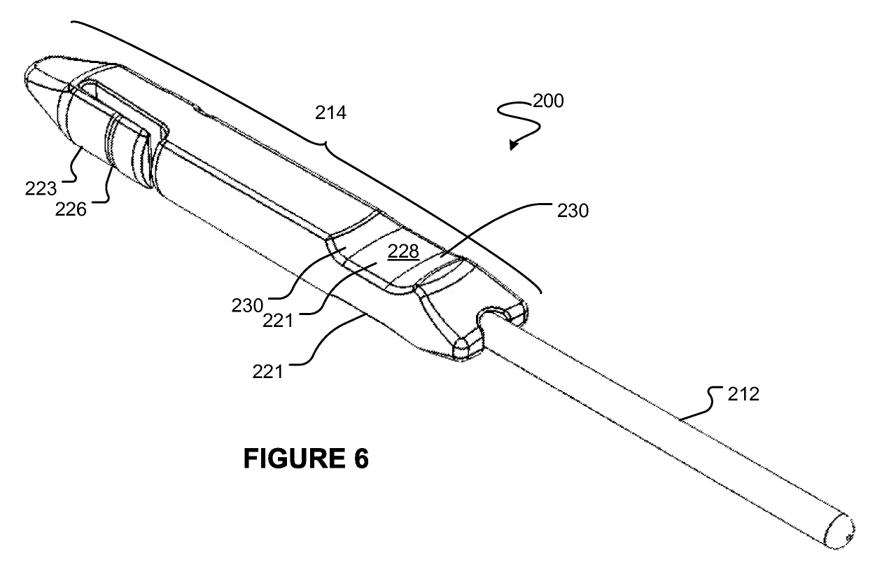

Opposing indentations 21 are located along the length of second rod 14 at a position corresponding with the position of the opposing ends of the outer arms of the paint spinner when second rod 14 is fully inserted into the paint spinner, i.e., with tapered portion 19 received within the inner arms or mouth of the paint spinner. In some embodiments, opposing indentations 21 may be notches with a flat bottom surface (as shown for example in FIG. 6, described below). In some embodiments, opposing indentations 21 are located approximately at the mid point along the length of adapter 10. In an example embodiment, indentations 21 may be located on second rod 14 approximately 1.5 inches from the connection point between first rod 12 and second rod 14.

In operation, a user may insert either the first rod 12 or the second rod 14 of adapter 10 into a bore of a mini roller cover, depending on the size of the bore. When a mini roller cover is mounted on adapter 10, the opposite end of adapter 10 is attached to a spinning mechanism, such as a paint spinner.

For example, for cleaning a mini roller cover of a smaller bore size, first rod 12 is inserted into the smaller bore. Tapered portion 15 and/or cylindrical portion 17 of first rod 12 provide suitable friction fit with the smaller bore. The second rod 14 is then inserted into a paint spinner with outer and inner arms or mouth. Since the opposing ends of outer arms of the paint spinner would typically be biased closer together than the smaller cross-sectional dimension of second rod 12 (e.g. height H2 of second rod 12), tapered first end 19 eases entry of second rod 14 by gradually prying apart the outer arms of the paint spinner. Second rod 14 is pushed into the paint spinner until opposing ends of the outer arms snap into place due to their bias toward each other into opposing indentations 21 to provide a secure fit. Simultaneously, tapered first end 19 would be received by the inner arms of the paint spinner to further secure the fit. Of course, second rod 14 may be attached to the paint spinner before the mini roller cover is secured on first rod 12.

For example, for cleaning a mini roller cover of a larger bore size, second rod 14 is inserted into the larger bore. Elongated body 22 and/or flexibly deformable portions 23 of second rod 12 provide suitable friction fit with the mini roller cover. First rod 12 and a portion of second rod 14 are then inserted into a paint spinner with outer and inner arms or mouth. Since the opposing ends of outer arms of the paint spinner would typically be biased closer together than the smaller cross-sectional dimension of second rod 14 (e.g. height H2 of second rod 12), tapered second end 18 eases entry of second rod 14 by gradually prying part the outer arms of the paint spinner. First rod 12 and a portion of second rod 14 is pushed into the paint spinner until opposing ends of the outer arms snap into place due to their bias toward each other into opposing indentations 21A and 21B to provide a secure fit. Of course, first rod 12 and a portion of second rod 14 may be attached to the paint spinner before the mini roller cover is secured on second rod 14.

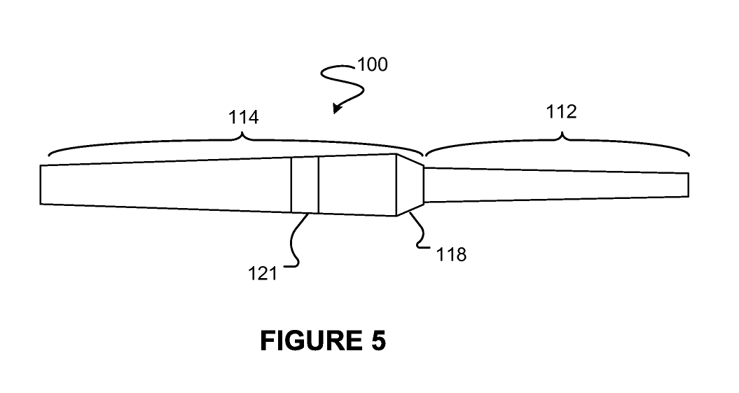

FIG. 5 is a top view of an adapter 100 according to an alternative embodiment of the invention. In this embodiment, the flexibly deformable portion is absent. A first rod 112 of adapter 100 is tapered. A second rod 114 of adapter 100 is also tapered. The tapers of first rod 112 and second rod 114 are dimensioned to form suitable friction fits with mini roller cover bores of first and second sizes, wherein the first size is smaller than the second size. Opposing indentations 121 (only one is illustrated in FIG. 5) provide locking engagement with the opposing ends of the outer arms of the paint spinner. Tapered portion 118 facilitates a portion of second rod 114 to ease between the opposing ends of the outer arms of the paint spinner when first end 112 is attached to the paint spinner.

FIG. 6 is an isometric view of an adapter 200 according to an alternative embodiment of the invention. Adapter 200 comprises a first rod 212. First rod 212 is substantially cylindrical and has only a very slight taper. First rod 212 is dimensioned to precisely fit within a bore of the same diameter, forming a suitable friction fit. Opposing indentations 221 are centrally located along the length of adapter 200 to allow locking with the opposing ends of the outer arms of a paint spinner regardless of whether first rod 212 or second rod 214 is coupled to the paint spinner. As illustrated in FIG. 6, each opposing indentation 221 comprise a notch with sloped surfaces 230 and a substantially flat bottom surface 228. Sloped surfaces 230 facilitate engagement and disengagement with the opposing ends of the outer arms of the paint spinner.

Flat bottom surfaces 228 may be rectangular in shape. Flat bottom surfaces 228 provides greater surface area for contact, and therefore enhanced fit, with the opposing ends of the outer arms of the paint spinner, since the contact surface of the opposing ends are typically flat and rectangular. This feature further minimizes wobble of adapter 200 even as the paint spinner rotates at high speeds. In some embodiments, the width of flat bottom surface 228 (i.e., the dimension transverse to the long axis of adapter 200) may range from 0.50 inches to 0.90 inches, or from 0.60 inches to 0.80 inches, or from 0.65 inches to 0.75 inches. In some embodiments, the length of flat bottom surface 228 (i.e., the dimension parallel to the long axis of adapter 200) may range from 0.30 to 0.60 inches, or from 0.40 to 0.50 inches. In some embodiments, the depth of opposing indentations 221 may range from 0.01 to 0.20 inches, or from 0.05 to 0.10 inches, be about 0.082 inches.

Flexibly deformable portion 223 has ribs 226 which provide additional friction fit when a mini roller cover is fitted over second rod 214.

As will be apparent to those skilled in the art in the light of the foregoing disclosure, many alterations and modifications are possible in the practice of this invention without departing from the spirit or scope thereof. For example, in some embodiments:
any of the tapers referred to above may comprise step tapers.
opposing indentations 21, 121, 221 may wrap around second rod 14, 114, 214 respectively instead of being provided on opposing surfaces.
first rod 12, 112, 212 may be detachable, with first rods of different dimensions being attachable to second rod 14, 114, 214 to fit different size smaller bored mini roller covers.

This application is intended to cover any variations, uses, or adaptations of the invention using its general principles. Further, this application is intended to cover such departures from the present disclosure as come within known or customary practice in the art to which this invention pertains and which fall within the limits of the appended claims. Accordingly, the scope of the claims should not be limited by the preferred embodiments set forth in the description, but should be given the broadest interpretation consistent with the description as a whole.

1. A paint spinner adapter for mini roller covers, the adapter comprising:
a first rod comprising a first end and a second end, the first rod configured to be friction fittable within a first bore of a mini roller cover;
a second rod comprising a first end a second end, the second rod configured to be friction fittable within a second bore of a different mini roller cover;
wherein the second end of the first rod is connected to the second end of the second rod;
wherein the second rod has a larger cross-sectional profile than the first rod; and
wherein the second rod comprises opposing indentations configured for locking engagement with opposing ends of outer arms of a paint spinner;

2. An adapter according to claim 1 wherein the second rod comprises a truncated circular cross-section.

3. An adapter according to claim 2 wherein the first rod comprises a substantially circular cross-section.

4. An adapter according to claim 3 wherein at least a portion of the first rod tapers from a smaller cross-sectional profile to a larger cross-sectional profile from the first end to the second end.

5. An adapter according to claim 4 wherein the first end of the second rod comprises a tapered section.

6. An adapter according to claim 5 wherein the second end of the second rod comprises a tapered section.

7. An adapter according to claim 6 wherein the second rod comprises a flexibly deformable portion which projects away from the second rod, whereby when the second rod is inserted into the second bore, the flexibly deformable portion deforms and thereby generates a force against the interior surface of the bore.

8. An adapter according to claim 7 wherein the first rod has a diameter of approximately 0.235 inches.

9. An adapter according to claim 8 wherein the second rod has a width of approximately 0.740 inches.

10. An adapter according to claim 9 wherein the indentations are located at approximately the middle of the length of the adapter.
